(19) United States
(12) Patent Application Publication
(10) Pub. No.: US 2015/0332308 A1
(43) Pub. Date: Nov. 19, 2015

(54) Predicting Swing Buyers in Marketing Campaigns

(71) Applicant: BANK OF AMERICA CORPORATION, Charlotte, NC (US)

(72) Inventor: Xiaohu Liu, West Chester, PA (US)

(73) Assignee: BANK OF AMERICA CORPORATION, Charlotte, NC (US)

(21) Appl. No.: 14/276,646

(22) Filed: May 13, 2014

(51) Int. Cl. G06Q 30/02

(52) U.S. Cl. CPC G06Q 30/0242

(57) ABSTRACT

In a marketing campaign, an individual whom we market to may be a swing buyer, a self buyer, or a non-persuadable non-buyer. A cost effective marketing strategy may focus on the swing buyers, who make a purchase when treated by the marketing campaign and do not purchase the product otherwise. Utilizing a randomized test and control data set including individuals randomly divided between a treatment group and a control group, three methods for predicting swing customers in a marketing campaign are proposed. One such method includes developing a first model corresponding to a likelihood that a member of control group is a buyer of the product, developing a second model corresponding to the likelihood that a non-buyer of the product is a member of control group, and determining a score corresponding to the likelihood that an individual is a swing buyer, using the first model and the second model.

### BACKGROUND

When a product is offered for sale, an organization may use a marketing campaign to encourage individuals to purchase the product in a marketplace. During a marketing campaign, different types of individuals may be encountered in the marketplace, such as “self-buyers”, “non-persuadable non-buyers”, and “swing buyers”. For example, a self-buyer is an individual that always buys the particular product, regardless of the marketing campaign. A non-persuadable non-buyer never buys the product regardless of any advertising and/or marketing campaign about the product. A swing buyer buys the product if he or she is addressed by the marketing campaign and does not buy the product if he or she is not addressed by the marketing campaign. Because self-buyers and non-persuadable non-buyers are unlikely to be influenced by a marketing campaign, any targeting of these individuals may add undue expense to the marketing campaign. As such, a need has been recognized to provide a cost-effective marketing strategy that is capable of identifying and/or presenting information to likely swing buyers.

### SUMMARY

Assume a large randomized test data set is available, where individuals were randomly divided into a test group (e.g., a treatment group) for receiving marketing treatment and a control group (e.g., an untreated group) not receiving marketing treatment. In some cases, a method for identifying and/or predicting swing customers in a marketing campaign may include determining, by a computer device, a first model corresponding to a likelihood that a member of the control group is a buyer of a product based on a plurality of observations corresponding to the control group. Further, a second model may be used to determine a likelihood that a non-buyer of the product is a member of the control group. The computer device may determine a score corresponding to a probability that a customer is a swing buyer using the first model and the second model.

In some cases, an apparatus for identifying and/or predicting swing customers in a marketing campaign may include a processor and a non-transitory memory device communicatively coupled to the processor. The memory device may store instructions that, when executed by the processor, cause the apparatus to predict, using a first model, a first probability that an individual in a control group will be a buyer of a product and/or predict, using a second model, a second probability that a non-buyer of the product is in the control group. In some cases, the non-transitory memory device may be further configured to store instructions that may determine a score based on the first probability and the second probability, the score corresponding to a probability that a person is a swing buyer.

In some cases, a system for identifying and/or predicting swing customers in a marketing campaign may include a data repository and a computer device communicatively coupled to the data repository. In some cases, the data repository may be configured to store historical information including a plurality of observations about a product offered by a business. In some cases, the historical information includes a large randomized test data set. The computer device may include at least one processor and a non-transitory memory device communicatively coupled to the processor. The non-transitory memory device may store instructions that, when executed by the processor, cause the computer device to associate a first portion of the historical information to a control group, corresponding to individuals not subject to a marketing campaign for the product and associate a second portion of the historical information to a test group, corresponding to individuals subject to the marketing campaign. In some cases, the non-transitory memory device may further store instructions that, when executed by the processor, cause the computer device to determine a first model corresponding to a likelihood that a member of the control group is a buyer of a product based on a plurality of observations about the control group, determine a second model corresponding to a likelihood that a non-buyer of the product is a member of the control group, and determine a score corresponding to a probability that a customer is a swing buyer, the score determined using the first model and the second model.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

A more complete understanding of aspects of the present disclosure and the advantages thereof may be acquired by referring to the following description in consideration of the accompanying drawings, in which like reference numbers indicate like features, and wherein:

FIG. 1 illustrates a schematic diagram of a general-purpose digital computing environment in which certain aspects of the present disclosure may be implemented;

FIG. 2 is an illustrative block diagram of a system for predicting swing buyers in a marketplace according to one or more aspects of the present disclosure;

FIG. 3 is a flowchart of an illustrative method for predicting swing buyers in a marketplace by, for example, the system of FIG. 2 according to one or more aspects of the present disclosure;

FIGS. 4A-C show illustrative charts including validation results of a first predictive model used to predict swing buyers in a marketplace according to one or more aspects of the present system;

FIGS. 5A-C show illustrative charts including validation results of a second predictive model used to predict swing buyers in a marketplace according to one or more aspects of the present system; and

FIGS. 6A-C show illustrative charts including validation results of a predictive score used to predict swing buyers in a marketplace according to one or more aspects of the present system.

### DETAILED DESCRIPTION

In the following description of the various illustrative implementations, reference is made to the accompanying drawings, which form a part hereof, and in which is shown by way of illustration various implementations in which the disclosure may be practiced. It is to be understood that other implementations may be utilized and structural and functional modifications may be made.

In a marketing campaign, an individual whom we market to may be a swing buyer, a self-buyer, or a non-persuadable non-buyer. A cost-effective marketing strategy should focus on the swing buyers who will purchase a product when the product is marketed to them but will not purchase the product if the product is not marketed to them. If we assume that a randomized test and control data is available, wherein the individuals are randomly divided into a test group for receiving treatment with the marketing campaign and a control group for not receiving treatment from the marketing campaign. A method for predicting swing customers in a marketing campaign may include determining a first model corresponding to a likelihood that a member of control group is a buyer of the product based on the control group data, determining a second model corresponding to a likelihood that a non-buyer of the product is a member of control group, and then determining a final score corresponding to a likelihood for an individual to be a swing buyer, using the first model and the second model.

A need has been recognized to provide a cost-effective marketing strategy that is capable of identifying and/or presenting information to likely swing buyers. To do so, one or more models may be used to identify individuals likely to be swing buyers. In some cases, developing a predictive swing buyer model uses a large randomized test data set. The randomized test data set corresponds to a test group, or treatment group, and a control group. The test group includes individuals that were randomly selected for receiving marketing treatment and the control group includes individuals that were randomly selected for not receiving marketing treatment. In some cases, as an example, each of the test group and the control group may include a large number of observations (e.g., at least 5000 observations, at least 10000 observations, and the like). In some cases, the number of individuals associated with the test group may be the same as the number of the individuals associated with the control group. While, in other cases, the number of individuals associated with the test group may be different from the number of individuals associated with the control group. In some observational studies using historical data, there is no well defined test group and control group. The set of individuals receiving the marketing treatment may be defined as the test group. However, the set of individuals not receiving the marketing treatment cannot be directly used as the control group, since the individuals not receiving treatment may be substantially different from the individuals receiving the treatment. In such cases, a pseudo control group, otherwise known as a simulated control group, may be created from a population of untreated individuals to match the individuals in the test group. For example, the simulated control group may be created by using one or more different methods, such as propensity score matching, nearest neighbor matching, and the like. In some cases, this type of artificially generated test and control data may be sufficient for modeling swing buyers. However, the quality of the data may vary on a case by case basis. Therefore, a data from a randomized test is highly recommended. Furthermore, an ideal randomized test runs for multiple months, at different times and/or in different campaigns. Based on the data from an ideal randomized test, if a swing buyer model is developed and performs well in each of the multiple months, then such a model may be more likely to perform well in the future.

In some cases, another method for identifying and/or predicting swing customers in a marketing campaign may include determining, by a computer device, a first model corresponding to a likelihood that a member of a test group is a buyer of a product based on a plurality of observations in the test group, and determining, by the computer device, a second model corresponding to a likelihood that a buyer of the product is a member of the test group. The computer device may be further configured to determine a score corresponding to a probability that a customer is a swing buyer. The score may be determined using the first model and the second model, as discussed below. In some cases, the size of the test group may be different from the size of the control group.

A user (e.g., an analyst, a marketer, and the like) may desire to use one or more different methods for predicting the likelihood that one or more of the consumers are swing buyers. For example, a first conventional method is based on the following probability decomposition formula:

$$P ( swing buyer ) = P ( buyer \vert test ) \{ 2 - \frac{1}{P ( test \vert buyer )} \} \qquad ( 0 )$$

Here, P(buyer|test) is the conditional probability of an individual being a buyer given the individual is in test group, i.e., the probability for an individual in test group to be a buyer. P(test|buyer) is the conditional probability of the individual being in the test group given the individual is a buyer of the product and/or service, i.e., the probability for a buyer to be in the test group. Based on this formula, the Probability Decomposition Method (PDM) for predicting the probability that an individual is a swing buyer is established. This method includes the steps of:
(i) using the individuals in a test group, develop a logistic regression model to predict P(buyer|test), the probability for an individual in the test group to be a buyer;
(ii) using the buyers in both the test group and the control group, develop a logistic regression model to predict P(test|buyer), the probability for a buyer to be in the test group; and
(iii) using the probability decomposition formula, equation (0), to calculate the probability for an individual to be a swing buyer, P(swing buyer).

This method (e.g., PDM) requires that the size (e.g., the number of observations) of the test group is equal to the size of the control group. Often, creating the test group to have a same size as the control group may not always be practical, may be difficult or even impossible. As such, it is desirable to have one or more methods that allow for the control group and the test group to be of different sizes. Another limitation with the probability decompositions method (PDM) is that only the buyers of the products and/or services and the individuals in the test group have been examined, while the non-buyers in the control group are not considered in predicting swing buyers. As a result, one or more modified methods may be used for predicting which of the consumers may likely be a swing buyer. In many cases, these methods may provide a more general framework for modeling swing buyers, such as by allowing a control group size to be different from the test group size, by considering records in the control group, and by considering non-buyers when determining models used for predicting swing buyers, as discussed more fully herein.

In some cases, one or more models may be used to predict swing buyers, and can be represented in different formulas. The following theorem discusses different ways of finding the probability for an individual to be a swing buyer when a randomized test data is available.

### Theorem:

Assume that a randomized test data set is available, wherein individuals are randomly divided into a test group and a control group, and that an individual is a self-buyer, a non-persuadable non-buyer, or a swing buyer. Then,

$$\begin{matrix}P ( S ) = P ( B \vert T ) - P ( B \vert C ) & ( 1 ) \\ P ( S ) = P ( B \vert T ) \{ 1 + \frac{{N}_{T}}{{N}_{C}} ( 1 - \frac{1}{P ( T \vert B )} ) \} & ( 2 ) \\ P ( S ) = P ( \overline{B} \vert C ) \{ 1 + \frac{{N}_{C}}{{N}_{T}} ( 1 - \frac{1}{P ( C \vert \overline{B} )} ) \} & ( 3 )\end{matrix}$$

where,
P(•) denotes a probability function;
S is the event that the individual is swing buyer;
T is the event that the individual is in the test group;
C is the event that the individual is in the control group;
B is the event that the individual is a buyer;
B̅ is the event that the individual is a non-buyer;
N_{T} is the number of records in test group; and
N_{C} is the number of records in control group.

Equation (1) states that the probability that an individual is a swing buyer, P(S), is equal to the difference between the probability that an individual is a buyer given that the individual is in the test group, P(B|T), and the probability that an individual is a buyer given that the individual is in the control group, P(B|C). In other words, the probability that an individual is a swing buyer is equal to the incremental buying probability i.e., the incremental treatment effect.

Equation (2) is a generalization of equation (0) discussed above. Unlike equation (0), equation (2) allows the test group size and the control group size to be different. In the special case where the test group size equals the control group size (N_{T}=N_{C}), then equation (2) reduces to

$$P ( S ) = P ( B \vert T ) ( 2 - \frac{1}{P ( T \vert B )} ) ,$$

which is equivalent to equation (0).

Equation (3) provides a different method to model the incremental buying probability. For example, the probability P( B̅|C) equals a probability that an individual is a non-buyer given that the individual is in the control group. Similarly, the probability P(C| B̅) corresponds to a probability that the individual is in the control group given that the individual is a non-buyer.

In general, when stating that “the individual is a buyer”, this phrase may be interpreted as the individual taking an action which a financial institution would desire to happen. For example, the individual may make a balance transfer, start actively using a credit card, and the like. In a payment collection campaign on past due customers, a customer's action which a financial institution desires to have is for the customer to make a payment. It is crucial to figure out which customer is a swing payer and can be persuaded to make a payment in payment collection campaigns.

A proof of the theorem states that:

For equation (1):

S is the event of the individual being a swing buyer, and A is the event of the individual being a self-buyer. Notice that in the test group, a buyer is either a swing buyer or a self-buyer. Also, in the control group, a buyer must be a self-buyer. Hence:

p(B|T)−P(B|C)=P(S∪A|T)−P(A|C) (4)

Since event S and event A are mutually exclusive, the above equation implies:

P(B|T)−P(B|C)=P(S|T)+P(A|T)=P(A|C) (5)

Since data is randomly divided into test and control, each individual is selected to be in the test group with the same probability regardless of the individual's type (swing buyer, self-buyer, or non-persuadable non-buyer). Hence,

P(T|S)=P(T), P(T|A)=P(T), P(C|A)=P(C). (6)

By Bayesian rule,

$$P ( S \vert T ) = \frac{P ( S ) P ( T \vert S )}{P ( T )} = \frac{P ( S ) P ( T )}{P ( T )} = P ( S ) . \qquad ( 7 )$$

Similarly,

P(A|T)=P(A), and P(A|C)=P(A). (8)

Substituting equation (7) and equation (8) into equation (5), we have,

P(B|T)−P(B|C)=P(S)+P(A)−P(A)=P(S). (9)

Proof of equation (2) in the theorem:

$$\frac{{N}_{T}}{{N}_{C}} = \frac{P ( T )}{P ( C )} \qquad ( 10 )$$

Since any buyer must be either in the control group or in the test group, we have P(C|B)+P(T|B)=1. This implies

$$1 - \frac{1}{P ( T \vert B )} = - \frac{P ( C \vert B )}{P ( T \vert B )} . \qquad ( 11 )$$

So,

$$\begin{matrix}P ( B \vert T ) \{ 1 + \frac{{N}_{T}}{{N}_{C}} ( 1 - \frac{1}{P ( T \vert B )} ) \} = & ( 12 ) \\ P ( B \vert T ) \{ 1 - \frac{P ( T )}{P ( C )} \times \frac{P ( C \vert B )}{P ( T \vert B )} \} = & ( 13 ) \\ P ( B \vert T ) \{ 1 - \frac{P ( T )}{P ( C )} \times \frac{\frac{P ( C ) P ( B \vert C )}{P ( B )}}{\frac{P ( T ) P ( B \vert T )}{P ( B )}} \} ( by Bayesian rule ) = & ( 14 ) \\ P ( B \vert T ) \{ 1 - \frac{P ( B \vert C )}{P ( B \vert T )} \} = & ( 15 ) \\ P ( B \vert T ) - P ( B \vert C ) = & ( 16 ) \\ P ( S ) ( by equation ( 1 ) ) & ( 17 )\end{matrix}$$

Proof of equation (3) in the theorem:

$$\frac{{N}_{C}}{{N}_{T}} = \frac{P ( C )}{P ( T )} . \qquad ( 18 )$$

Since any non-buyer must be either in control group or in test group, we get P(C| B̅)+P(T| B̅)=1. This implies

$$1 - \frac{1}{P ( C \vert \overline{B} )} = - \frac{P ( T \vert \overline{B} )}{P ( C \vert \overline{B} )} \qquad ( 19 )$$

Hence,

$$\begin{matrix}P ( \overline{B} \vert C ) \{ 1 + \frac{{N}_{C}}{{N}_{T}} ( 1 - \frac{1}{P ( C \vert \overline{B} )} ) \} = & ( 20 ) \\ P ( \overline{B} \vert C ) \{ 1 - \frac{P ( C )}{P ( T )} \times \frac{P ( T \vert \overline{B} )}{P ( C \vert \overline{B} )} \} = & ( 21 ) \\ P ( \overline{B} \vert C ) \{ 1 - \frac{P ( C )}{P ( T )} \times \frac{\frac{P ( T ) P ( \overline{B} \vert T )}{P ( \overline{B} )}}{\frac{P ( C ) P ( \overline{B} \vert C )}{P ( \overline{B} )}} \} ( by Bayesian rule ) = & ( 22 ) \\ P ( \overline{B} \vert C ) \{ 1 - \frac{P ( \overline{B} \vert T )}{P ( \overline{B} \vert C )} \} = & ( 23 ) \\ P ( \overline{B} \vert C ) - P ( \overline{B} \vert T ) = & ( 24 ) \\ \{ 1 - P ( B \vert C ) \} - \{ 1 - P ( B \vert T ) \} = & ( 25 ) \\ P ( B \vert T ) - P ( B \vert C ) = & ( 26 ) \\ P ( S ) ( by equation ( 1 ) ) & ( 27 )\end{matrix}$$

End of the proof.

Based on the theorem, one or more methods may be used for modeling the probability that an individual is a swing buyer. For example, a first method, based on equation (1) may be defined as:
(i) using all individuals in the test group, develop the test group model P₁ to predict P (buyer|test), the probability that an individual in the test group is a buyer, by logistic regression;
(ii) using all individuals in control, develop the control group model P₂ to predict P (buyer|control), the probability that an individual in the control group is a buyer, by logistic regression;
(iii) for each individual, create a score corresponding to the probability that an individual is a swing buyer as:

score=P₁−P₂. (28)

A second method based on equation (2) is defined as:
(i) using all individuals in the test group, develop a test group model P₁ to predict P (buyer|test), the probability that an individual in the test group is a buyer, by logistic regression;
(ii) using all buyers from both the test group and the control group, develop a model P₃ to predict P(test buyer), the probability that a buyer is in the test group, by logistic regression; and
(iii) for each individual, create a score corresponding to the probability that an individual is a swing buyer as:

$$score = {P}_{1} \{ 1 + \frac{{N}_{T}}{{N}_{C}} ( 1 - \frac{1}{{P}_{3}} ) \} . \qquad ( 29 )$$

While the second method may look similar to the probability decomposition method (PDM) based on equation (0), unlike the PDM method it does not require the size of the test group and the size of the control group to be equal.

In a third method, the observations in control group and the non-buyers observations from both test group and control group are used to model the probability that an individual is a swing buyer. The third method based on equation (3) is defined as:
(i) using all individuals in control, develop the control group model P₂ to predict P (buyer|control), the probability that an individual in the control group is a buyer, by logistic regression;
(ii) using all non-buyers from both the test group and the control group, develop a model P₄ to predict P(control non-buyer), the probability that a non-buyer is in the control group, by logistic regression.
(iii) for each individual, create a score corresponding to the probability that an individual is a swing buyer as:

$$score = ( 1 - {P}_{2} ) \{ 1 + \frac{{N}_{C}}{{N}_{T}} ( 1 - \frac{1}{{P}_{4}} ) \} . \qquad ( 30 )$$

In the following, a real-world example of the customer payment collection problem, such as payment collection on past due accounts, is discussed. The probability of an individual being a swing payer is modeled. In this case, the action that a financial institution desires a customer to take is not “buying a product”, but “making a payment”. An effective payment collection campaign focuses on those swing payers who make a payment only when receiving collection calling treatment. Based on equation (1) of the theorem, the probability for an individual to be a swing payer is equal to the incremental payment probability caused by calling treatment, the incremental calling treatment effect. This fact provides the basis for validating a score that predicts the probability of swing payer.

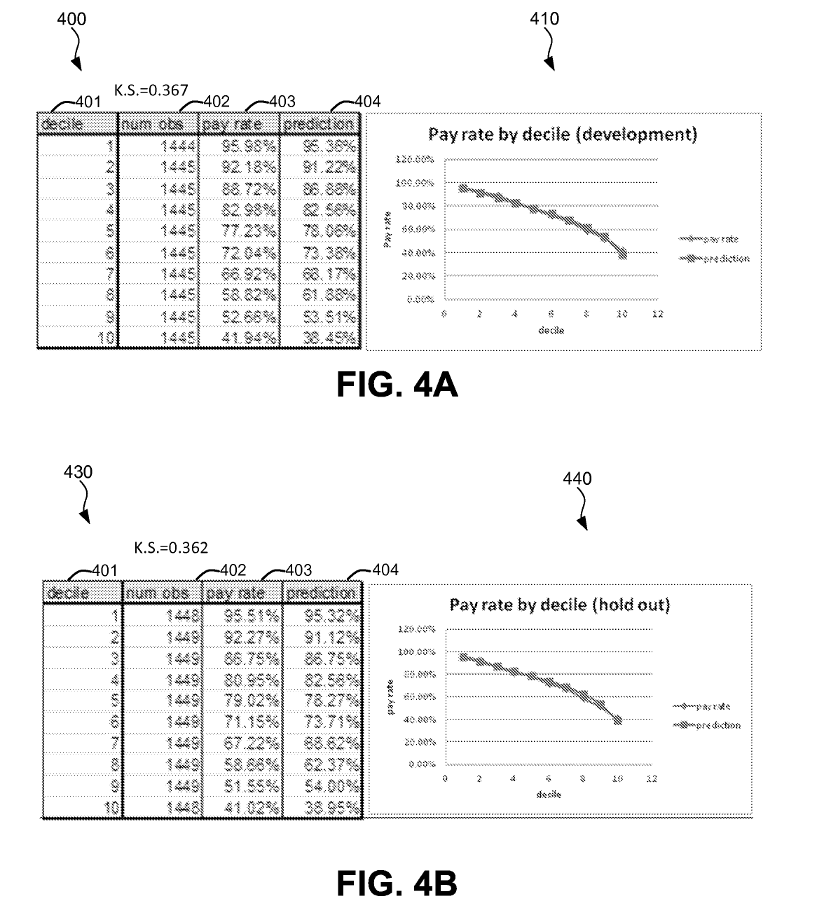

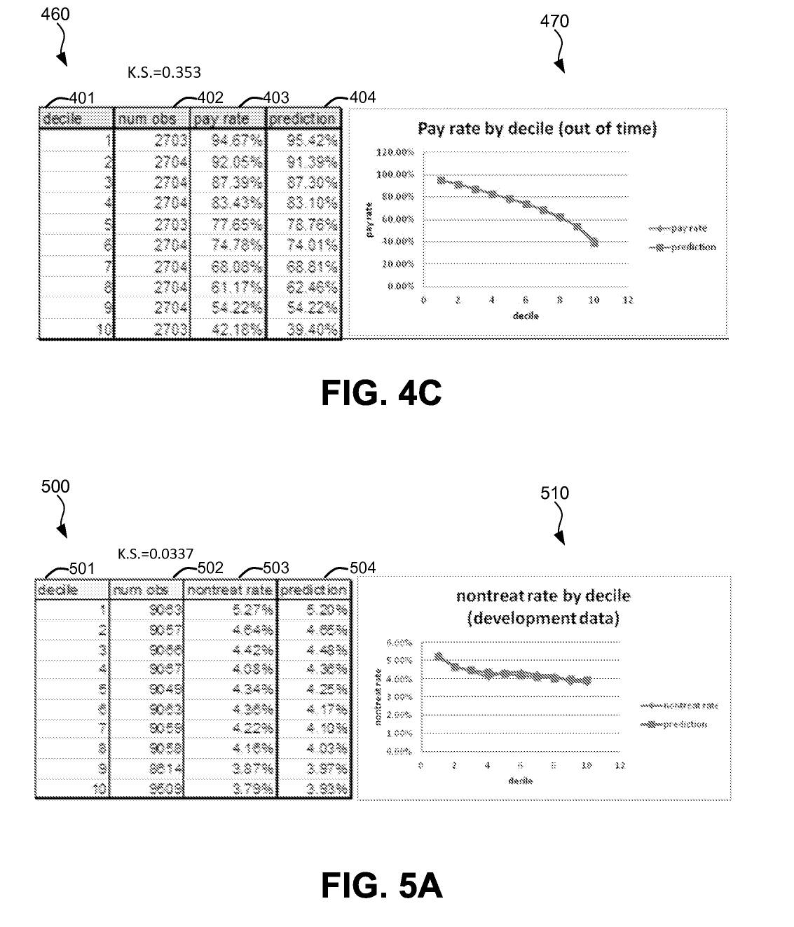

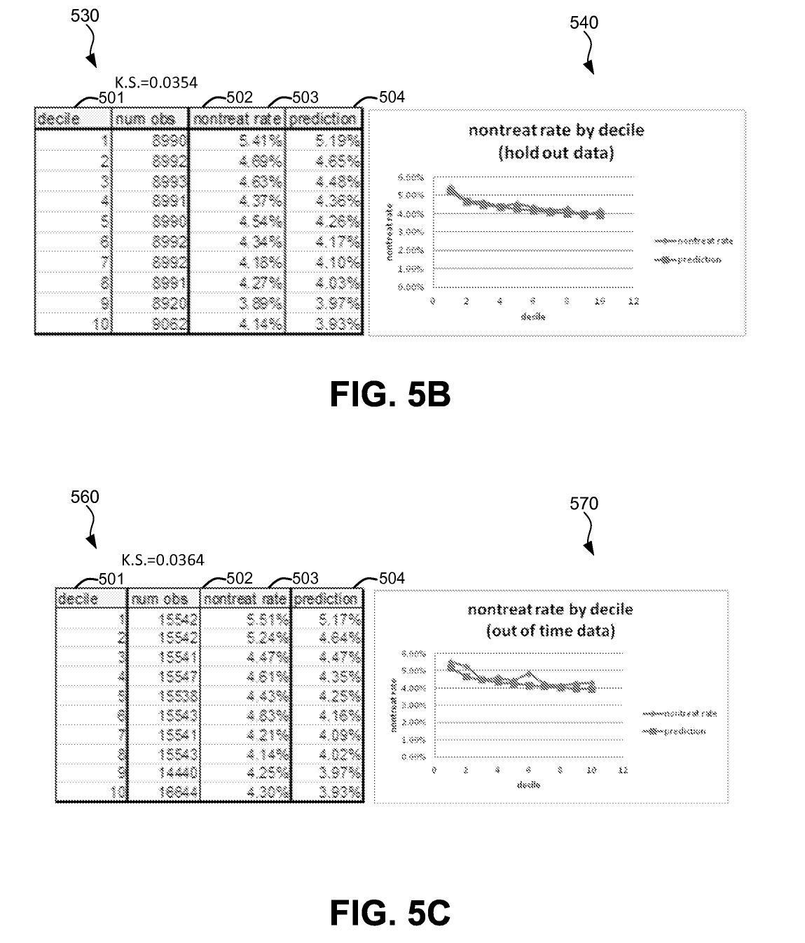

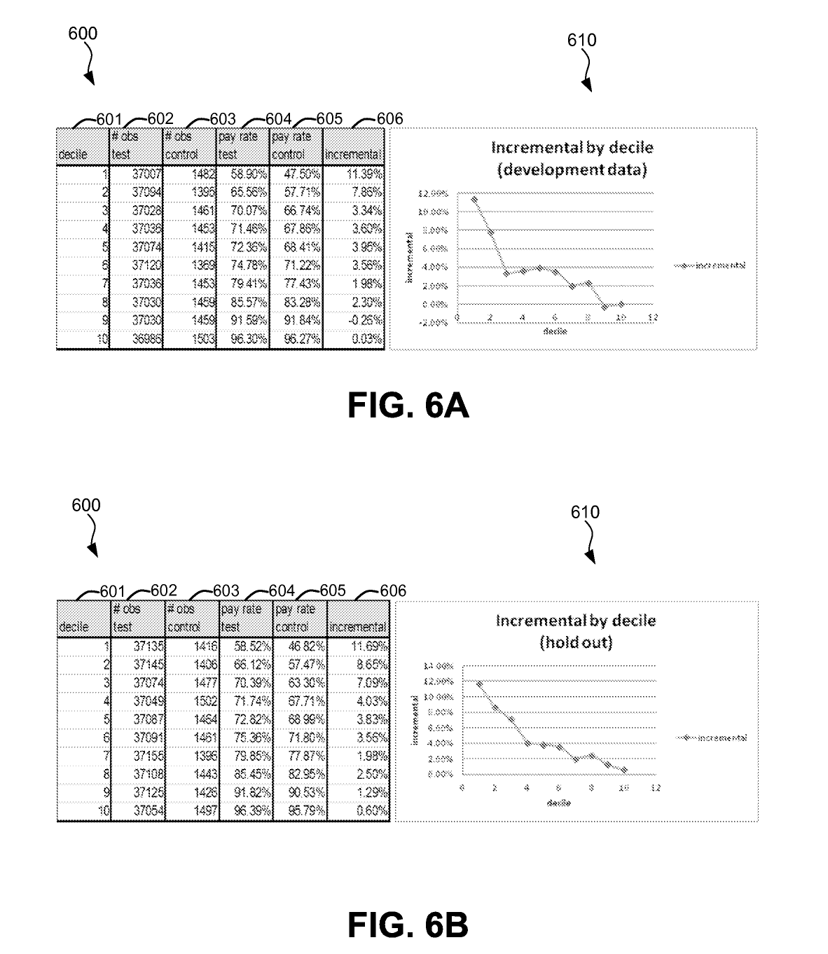

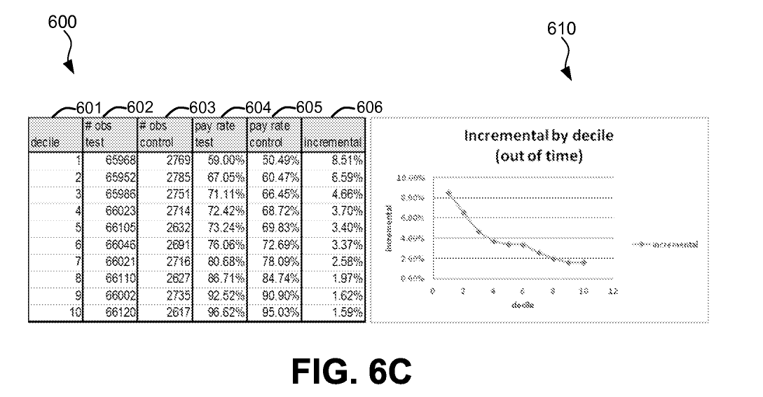

FIGS. 4A-C show illustrative charts including validation results of a first predictive model P₂, FIGS. 5A-C show illustrative charts including validation results of a second predictive model P₄, and FIGS. 6A-C show illustrative charts including validation results of a predictive score calculated using P₂ and P₄ used to predict swing payers in payment collection according to an illustrative implementation of one or more aspects of the present system. In this example, the historical data includes data obtained over four months. In some cases, such as when developing a model for predicting likely swing payers, the historical information may be used as a whole, or may be divided for different uses. In this illustrative example, of the four months of data, two months of that data are randomly divided into a model development data set (e.g., approximately 50%) and a hold out validation data set (e.g., approximately 50%), and the remaining two months of that data are used as out of time validation data set. In this example, the number of observations in the development data associated with the test group is N_{T}=370441, and the number of observations associated with the control group is N_{C}=14449. As can be seen, the number of observations associated with the test group is not required to be equal to the number of observations associated with the control group.

In real practice, all the three methods based on the theorem may be tested. Which particular method works best may depend on the data that is available. Here, equation (3), and the associated third method discussed above, is used as an illustrative example A computing device may implement a step to apply logistic regression to the observations in control group to develop a control group payment likelihood model P₂, to estimate P(payer control). In some cases, the control model may include one or more different variables selected from a larger group of candidate predictors. The model variables may come from credit bureau data, macro-economic data, internal account transaction data associated with financial products such as credit card, checking, depositing, mortgage, and the like. Once determined, the model may be evaluated and/or validated using the development data, the hold-out data, and/or the out of time data.

For example, FIGS. 4A-4C illustrate a validation of the control group model P₂ using different data. FIG. 4A illustrates a validation of the control group model P₂ using the control group of the development data, FIG. 4B illustrates a validation of the control group model P₂ using the control group of the hold-out data, and FIG. 4C illustrates a validation of the control group model P₂ using the control group of the out of time data. For example, the column 401 illustrates a ranking assigned to a range of observations based on the probability that the payer (e.g., buyer) is a member of the control group. In the illustrative example, the observations are divided into deciles, but other such groupings may be used. For example, the results may be sorted based on whether the predicted pay rate falls within different ranges of probabilities (e.g., near 0% to about 25%, near 25% to about 50%, near 50% to about 75%, and near 75% to about 100%), or another such grouping mechanism. Column 402 shows the number of observations associated with each decile. The chart 410 of FIG. 4A illustrates a comparison between the realized payer percentages shown in column 403 with a predicted payer percentages shown in column 404. As can be seen, the model P₂ illustrates a close correlation between the actual payer rate shown in column 403 and the predicted payer rate shown in column 404. Similarly, chart 440 of FIG. 4B illustrates a close correlation between the realized payer rate and the predicted payer rate based on hold out validation data. The chart 460 of FIG. 4C also illustrates a close correlation between the realized payer rate and the predicted payer rate based on out of time validation. Further, the rank ordering is also strong in each validation.

In some cases, the computing device may implement step (ii) using the observations associated with non-payers from both test group and control group to develop a logistic regression model P₄ to predict P(control|non-payer), the probability that a non-payer (e.g., a non-buyer) belongs to the control group (e.g., not subject to a marketing campaign). In this step, a binary flag is used to facilitate the logistic regression, where the flag is equal to 1 if the observation is in control group, and equal to 0 otherwise. The model P₄ may contain a number (e.g., 2) of variables that are selected from a larger number of candidate predictors, such as the predictors discussed above. Once determined, the model may be validated using the development data, the hold-out data, and/or the out of time data.

FIGS. 5A-5C show results of different validations of the model P₄ for predicting P(control|non-payer) using non-payers in the development data (e.g., FIG. 5A), non-payers in the hold-out data (e.g., FIG. 5B), and non-payers in the out of time data (e.g., FIG. 5C). The tables 500, 530, and 560 illustrate deciles assigned to a rank ordering of the observations in the data set in column 501, the number of observations associated with each decile in column 502, a realized non-treat rate (i.e., a percentage of observations in the control group) with each decile in column 503, and a predicted non-treat rate determined using the model P₄ with each decile in column 504. The charts 510, 540, 570 overlay the realized non-treat rate associated with each decile and the predicted non-treat rate for the non-payers in the development data, the non-payers in the hold-out data, and the non-payers in the out of time data, respectively. As can be seen, the model P₄ may generally provide a relatively weaker rank ordering of the non-treat rate. Nonetheless, the model P₄ is a decent model in rank ordering the non-treat rate for the non-payers. In practice, developing model P₄ may be technically challenging.

In some cases, the computing device may implement a third step of the illustrative third method to create the final score for predicting the probability that an individual is a swing payer (e.g., buyer). In this illustrative example, the number of observations associated with the test group is N_{T}=370441, which is not equal to the number of observations in the control group N_{C}=14449. To create the final score, the observations from both the test group and the control group are combined. Model P₂ and model P₄ can then be applied to the combined data to score everybody. Then final score is calculated using equation (30):

$$score = ( 1 - {P}_{2} ) \{ 1 + \frac{14449}{370441} ( 1 - \frac{1}{{P}_{4}} ) \} .$$

The validations of the score using the development data, hold-out data, and out of time data are displayed in FIGS. 6A-6C.

Column 601 shows a designation of a ranking (e.g., a decile ranking) of the observations used to validate the score using equation (21). Column 602 shows the number of observations associated with each decile rank that were part of the test group, while column 603 shows the number of observations associated with each decile rank that were part of the control group. Column 604 and 605 illustrate a realized pay rate for individuals in the test group and the control group, respectively. Column 606 shows an illustrative incremental pay rate difference that may result from treating individuals associated with a particular decile rank. Based on equation (1) of the theorem, the incremental pay rate at decile level is about equal to the observed percentage of swing payers. Evidently, treating individuals in a higher decile rank (e.g., decile 1, decile 2, decile 3, and the like) may have a greater effect than treating individuals in a lower decile rank (e.g., decile 10, decile 9, decile 8, and the like). The graphs 610, 640, 670 provide a visual representation of the data in column 606 of the tables 600, 630, and 660, respectively.

FIGS. 6A-C show the validation results of the final score of swing payer probability, with the validation result on the development data shown in FIG. 6A, the validation result on hold-out data shown in FIG. 6B, and the validation result on out of time data shown in FIG. 6C. Even though the model P₄ used in the prediction may provide a relatively weak rank ordering performance, the final score rank orders the incremental pay rate very well, as shown in column 606. Based on equation (1) of the theorem, the incremental payment rate in column 606 may be recognized as the percentage of swing payers at each decile. In some cases, one or more of method 1, method 2 or method 3 may be used alone, or in combination, to determine a particular sub-group of individuals having a greater probability for being swing buyers when subject to a marketing campaign. In some cases, the results obtained from method 3 may provide more reliable results than those received from method 1 and/or method 2. In practice, each of the different methods may be performed for a particular population to find out which method may be more appropriate for the available data. In some cases, a combination of methods may be used.

In some cases, the incremental percentages of column 606 may be used to indicate which sub-group (e.g., decile 1, decile 2, and the like) may include a higher percentage of swing payers. This information may, in turn, be communicated to a marketing system for use in developing and/or communicating a marketing campaign for a product and/or service. For example, in FIG. 6A, deciles 1 and 2 illustrate a high likelihood that swing payers may be included in these sub-groups (e.g., about 11% and about 8%, respectively). The remaining deciles may include percentages of potential swing payers between about 3% to near zero. As such, when the scores are communicated to the marketing system, a marketing computer may determine that a marketing campaign may be more effective and/or more cost effective when targeted towards the sub group of users corresponding to the top deciles (e.g., decile 1, decile 2, and the like), while not targeting the sub-groups least likely to include swing payers (e.g., decile 10, decile 9, and the like). The validation data shown in FIGS. 6B and 6C shows similar results. For example, the top three deciles of FIG. 6B show that likely swing payers may be between about 7% to about 12% of these sub-groups, while the remaining seven sub-groups may include less than 3% of potential swing payers. In this case, the marketing computer may determine that targeting the individuals associated with the top three deciles may be more cost effective and/or more effective than targeting individuals associated with the other deciles. Similarly the top two deciles of FIG. 6C indicate that the top two deciles may include between about 6.5% to about 8.5% of potential swing payers. As such, the marketing system may communicate the marketing campaign to one or more individuals associated with those sub-groups. As such, the systems and methods discussed herein may be used to predict a likelihood that a particular individual, or group of individuals, may likely be swing payers. This information may, in turn, be used to design a cost effective marketing campaign for use by a business organization, such as a financial institution.

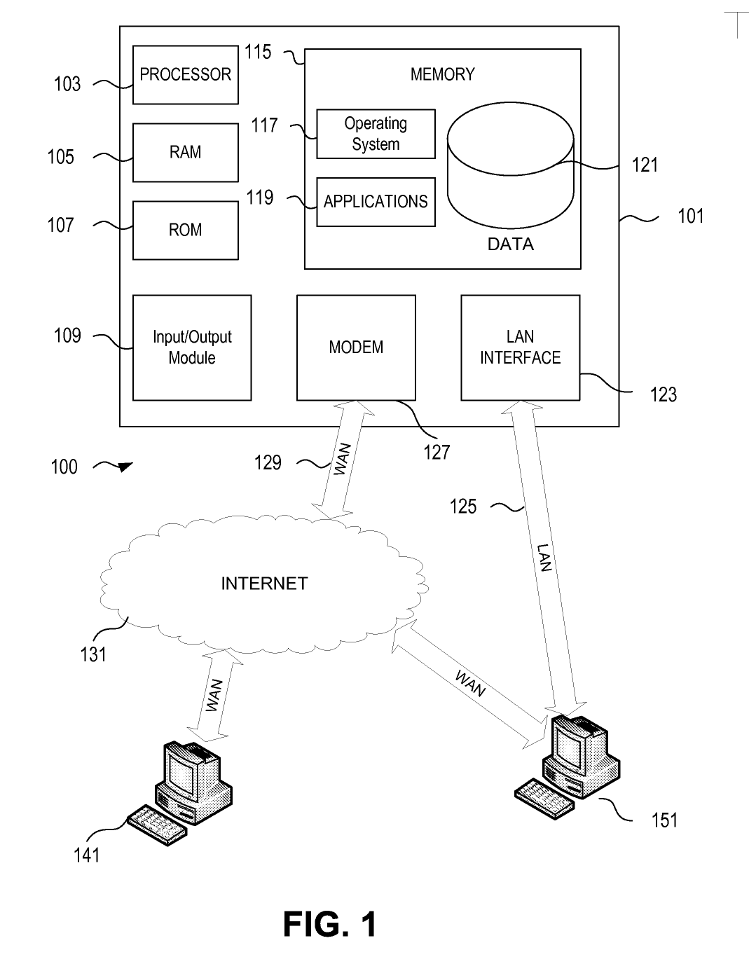

In some cases, the methods for determining likely swing buyers may be performed by a computing system implemented by a financial institution. For example, FIG. 1 illustrates a block diagram of a generic computing device (e.g., a computer server 101) of a computing environment 100 that may be used according to an illustrative implementation of the disclosure. The server 101 may have a processor 103 for controlling overall operation of the server and its associated components, including RAM 105, ROM 107, input/output (I/O) module 109, and a memory 115.

The I/O module 109 may include a microphone, keypad, touch screen, and/or stylus through which a user of the server 101 may provide input, and may also include one or more of a speaker for providing audio output and a video display device (e.g., a user interface) for providing textual, audiovisual and/or graphical output. Software may be stored within the memory 115 and/or other storage to provide instructions to the processor 103 for enabling the server 101 to perform various functions. For example, the memory 115 may store software used by the server 101, such as an operating system 117, one or more application programs 119, and an associated database 121. Alternatively, some or all of the computer executable instructions utilized by the server 101 may be embodied in hardware or firmware (not shown). As described in detail below, the database 121 may provide centralized storage of account information and account holder information for the entire business, allowing interoperability between different elements of the business residing at different physical locations.

The server 101 may operate in a networked environment supporting connections to one or more remote computers, such as the terminals 141 and 151. The terminals 141 and 151 may be personal computers or servers that include many or all of the elements described above relative to the server 101. The network connections depicted in FIG. 1 may include a local area network (LAN) 125 and a wide area network (WAN) 129, but may also include other networks. When used in a LAN networking environment, the server 101 is connected to the LAN 125 through a network interface or adapter 123. When used in a WAN networking environment, the server 101 may include a modem 127 or other means for establishing wired and/or wireless communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program 119 used by the server 101 according to an illustrative implementation of the disclosure may include computer executable instructions for invoking user functionality related to communication, such as email, short message service (SMS), and voice input and speech recognition applications.

The server 101 and/or the terminals 141 or 151 may also be mobile terminals (e.g., a cell phone, a tablet computer, a laptop computer, a smart phone, and the like) that may include various other components, such as a battery, speaker, and/or antennas (not shown).

The disclosure is operational with numerous other general purpose or special purpose computing system environments or configurations. Examples of computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules may include routines, programs, objects, components, data structures, and the like for performing particular tasks or implementing particular abstract data types. The disclosure may also be practiced in distributed computing environments where tasks are performed by remote processing devices that are linked through a communications network. In a distributed computing environment, program modules may be located in both local and remote computer storage media including memory storage devices.

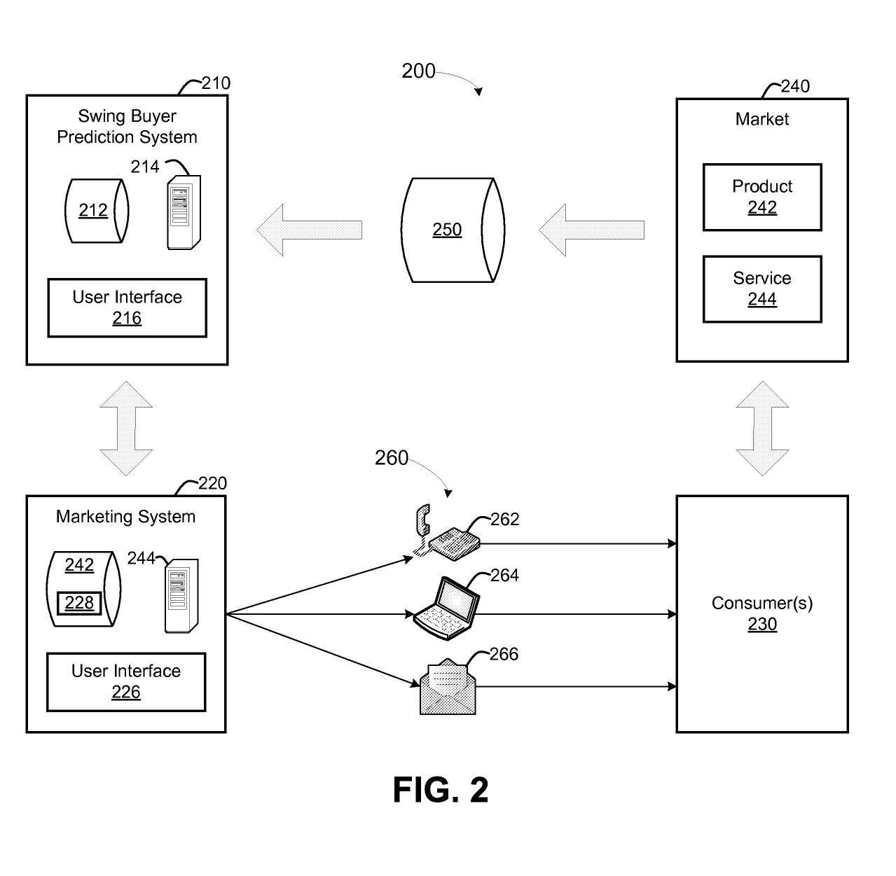

FIG. 2 is an illustrative block diagram of a system 200 for predicting swing buyers in a marketplace 240 associated with a business organization according to one or more aspects of the present disclosure. In the marketplace 240, different types of consumers 230 may be encountered, such as swing buyers, self-buyers, and/or non-persuadable non-buyers. Swing buyer are consumers, that are persuadable to buy the product 242 and/or service 244 if they are treated in the marketing campaign 228, but will not buy the product if they do not receive marketing treatment. Self-buyers are individuals who always buy the product 242 and/or service 244. As such, there is often no need to persuade them, such as by treating them with the marketing campaign 228. Similarly, non-persuadable non-buyers are individuals who never buy the product 242 and/or service 244. Such non-persuadable non-buyers are unlikely to be persuaded to make a purchase even when subject to the marketing campaign 228. As such, the success and/or failure of a marketing campaign 228 may be linked with the ability to determine which individuals are likely to be the swing buyers. In other words, a cost-effective marketing strategy may be focused, at least in part, on identifying the swing buyers, because marketing efforts directed to the self-buyers and/or the non-persuadable non-buyers are often not necessary. Therefore, marketing efforts directed toward the self-buyers and/or the non-persuadable non-buyers may be an inefficient use of the money invested in the marketing campaigns.

The illustrative system 200 may include a swing buyer prediction system 210, a marketing system 220 communicatively coupled to the swing buyer prediction system 210 and configured to provide a marketing campaign based, at least in part, on predictions provided by the swing buyer prediction system 210. One or more consumers 230 may, or may not, participate in the marketplace 240 for a particular product 242 and/or service 244 offered by a business organization. In some cases, the system 200 may include a data repository 250 that may be configured to store historical transaction information (e.g., observations) about actions performed (or not performed) by the consumers 230 in the marketplace 240. These observations may be used by the swing buyer prediction system 210 when predicting which of the consumers 230 may likely be a swing buyer.

In some cases, predictions made by the swing buyer prediction system 210 may be communicated to the marketing system 220, such as via a network, for use in creating and/or disseminating a marketing campaign to one or more of the consumers 230 via one or more communication methods, such as a telephone 262, a computer 264, and/or mail delivery 266. The marketing system 220 may include a data repository 222, a computer device 224 (e.g., the server 101), and/or a user interface 226. In some cases, one or more predictions about one or more consumers' likelihood of being a swing buyer may be stored in the data repository 222. In some cases, the marketing system 220 may store information about the product 242 and/or the service 244 offered in the marketplace 240 for use when creating a marketing campaign to present to the one or more consumers 230 predicted to be a likely swing buyer. In some cases, the information about a marketing campaign 228 and/or one or more predictions about the consumers 230 may be stored in the data repository 222. In some cases, a user may access the marketing system 220 via the user interface 226 and may provide information about the success and/or failure of a particular marketing campaign, including feedback about one or more predictions about whether certain consumers were likely to be swing buyers. In some cases, this feedback information may be communicated to the swing buyer prediction system 210, stored in the data repository 250, or both, such that the feedback may be used to evaluate one or more of the models. In some cases, this information may be used to improve one or more of the models used when predicting likely swing buyers.

In some cases, the swing buyer prediction system 210 may include a data repository 212, such as the memory 115 in FIG. 1, one or more computer devices 214 (e.g., the server 101) and/or a user interface 216. In some cases, the computer device 214 may be communicatively coupled to the marketing system 220 and/or the data repository 250 via one or more networks (e.g., the LAN 125, the WAN 129, and the like). For example, the swing buyer prediction system 210 may request and/or receive historical transaction information about consumer 230 activity in the marketplace 240 from the data repository 250. The swing buyer prediction system 210 may use the historical transaction information to predict which one(s) of the consumers 230 may likely be a swing buyer of a particular product and/or service offered by the business organization in the marketplace 240. In some cases, the historical information may include a large randomized data set including individuals subject to a marketing campaign, the test group, and individuals not subject to the marketing campaign, the control group. In other cases, a randomized test data set may not be available. In such cases, the historical transaction information may be used to create at least a pseudo control group of individuals that may be assumed to not be subject to a marketing campaign for the product and/or service, and a test group that may be subject to the marketing campaign.

In some cases, a large randomized test data set included in the historical transaction information may include individuals that were randomly assigned to the test group and to the control group. In some cases, the historical information may include information about one or more transactions and/or potential transactions between consumers and the business organization in the marketplace, such that the historical information may include observations about whether or not a purchase was made subject to the one or more transaction and/or potential transactions. The information associated with each of the test group and the control group may be used to create one or more models that may be used to predict a likelihood that an individual is a swing buyer. These predictions may then be communicated via a network to the marketing system 220 for use in creating and/or communicating one or more marketing campaigns. In some cases, the swing buyer prediction system 210 may receive information about the success and/or failure of a marketing campaign that was utilized in response to the predictions about likely swing buyers. In such cases, the feedback information may be received via a network from the marketing system 220 and/or the data repository 250. In some cases, a user may access the swing buyer predication system 210 via a user interface 216. When accessing the swing buyer prediction system 210, the user may be presented with information useful in creating, validating and/or implementing different models used when predicting which of the consumers are likely to be swing buyers. For example, the user may view one or more user interface screens that are configured to present a report including at least a portion of the historical presentation information, one or more methods for predicting which consumers may be likely to be a swing buyer, and the like.

In some cases, consumer actions of buying and/or purchasing may generally be thought of as a customer action that a business organization (e.g., a financial institution) would desire a customer to perform in reference to a product 242 and/or service 244. For example, when a financial institution implements an account collection procedure, an action of making a payment may be considered the desirable customer action that a financial institution may desire the consumers 230 to perform. In such procedures, determining which one(s) of the consumers would likely to be a swing payer may impact an overall success or failure of a particular marketing campaign 228. For example, targeting the marketing campaign 228 towards the consumers 230 having the highest likelihood of being a swing buyer may increase (e.g., maximize) the number of consumers persuaded to buy a particular product 242 and/or service 244 in response to the marketing campaign 228.

When developing the marketing campaign 228, information, such as historical transaction information, credit bureau information, and the like, stored in the data repository 250, may be available as potential predictors for use in developing models useful in identifying which consumers 230 are likely to be a swing buyer(s). In such cases, the data repository may include a randomized test data set where individuals associated have been assigned (e.g., randomly selected) to different groups, such as a test group selected for treatment (e.g., subject to the marketing campaign 228) and a control group selected for no treatment (e.g., not subject to the marketing campaign 228).

Instructions, when executed by the processor 103, may cause the computer device 214 to determine the first model, P₂, based on a plurality of historical observations about a control group using logistic regression, wherein the control group corresponds to a group of individuals not subject to a marketing campaign for the product and/or to determine the second model, P₄, based on a number of historical observations about non-buying members of the control group and non-buying members of a treatment group (e.g., a test group) In some cases, the P₄ may be determined using logistic regression using a dependent variable indicative of whether or not a non-buyer belongs to the control group. The computer device 214 may be configured to determine a score for each observation of the plurality of observations included in the historical information using P₂ and P₄. Further, the apparatus may be configured to rank the score determined for each observation in a set of transaction data to determine individuals that are more likely to be swing buyers. For example, the scores may be compared to a criterion corresponding to a score indicative of a likelihood that a person is likely to purchase the product when subject to the marketing campaign for the product and communicate marketing information to individuals associated with the scores that meet the criterion, such as by communicating the information via the user interface 216.

In some cases, the computer device 214 may be configured to communicate a report indicative of at least the likely swing buyers to a user, such as via the user interface 216 and/or using another reporting device or medium (e.g., a printer, an email, a text message, and the like). The report may be used when developing a marketing campaign for the product. In some cases, the user interface 216 may be local to the computer device 214. In some cases, the user interface 216 may be separate from and located at a different geographical location from the computer device 214 and may communicate via a network (e.g., the Internet, a WiFi connection, a telecommunications network, the LAN 125, the WAN 129, and the like). Further, the computer device 214 may communicate the marketing information to the marketing system 220 for inclusion in or to inform the creation of the marketing campaign 228.

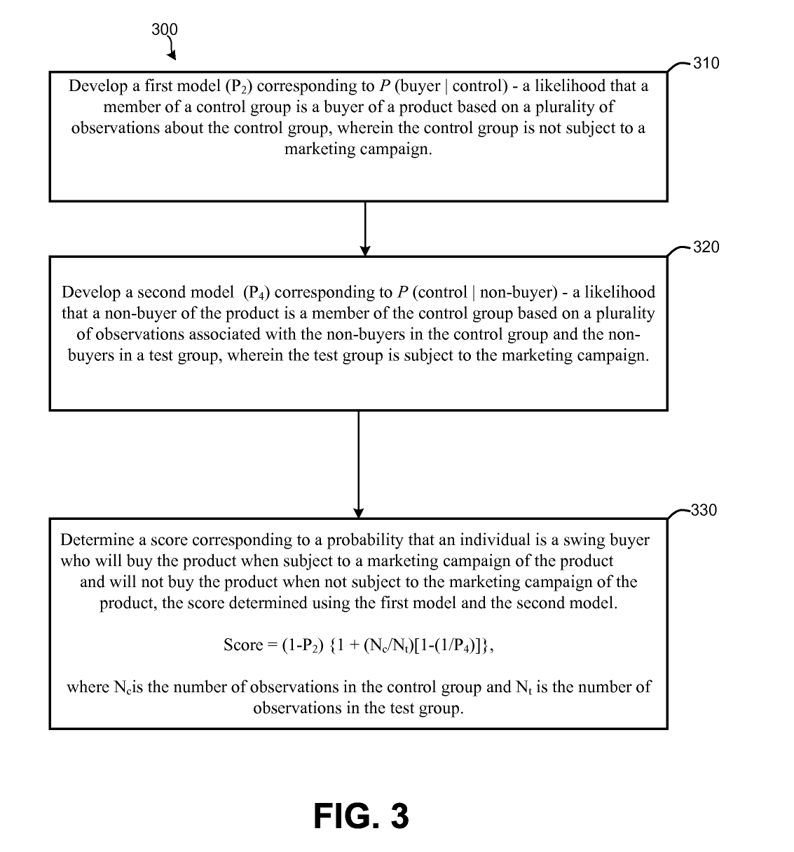

FIG. 3 is a flowchart of an illustrative method 300 for predicting likely swing buyers in a marketplace by the system 200 of FIG. 2 according to one or more aspects of the present disclosure. At 310, the method 300 may begin by determining, by the computer device 214, the first model P₂ corresponding to a likelihood that a member of a control group is a buyer of a product based on a plurality of observations about the control group. At 320, the computer device 214 may be configured for determining the second model P₄ corresponding to a likelihood that a non-buyer of the product is a member of the control group. At 330, the computer device 214 determines a score corresponding to a probability that a customer is a swing buyer, who will buy the product when subject to a marketing campaign 228 for the product and will not buy the product when not subject to the marketing campaign 228. The score may be determined using the first model and the second model, such as by using the equation (30) discussed above. When using the methods discussed above, the size of the control group may or may not be equal to the size of the treatment group.

In some cases, the computer device 214 may be capable of processing instructions that cause the computer device 214 to determine the first model and the second model based, at least in part, on historical transaction information associated with potential purchasers of the product, the historical transaction information corresponding to a specified time period. Further, the computer device 214 may receive the historical transaction information including transactional information about one or more products offered by an organization, the historical data including observations about two or more customers of the organization. The computer device 214 may then determine whether the historical information includes information about individuals associated with either the test group or the control group. For example, the historical information may include a large randomized test data set, wherein the individuals were randomly assigned to a test group and a control group. In some arrangements, the number of observations associated with the test group may be equal to the second number of observations associated with the control group. In some arrangements, the number of observations associated with the test group may not be equal to the number of observations associated with the control group.

Although not required, one of ordinary skill in the art will appreciate that various aspects described herein may be embodied as a method, a data processing system, or as a computer-readable medium storing computer-executable instructions. Accordingly, those aspects may take the form of an entirely hardware implementation, an entirely software implementation or an implementation combining software and hardware aspects. For example, a computer-readable medium storing instructions to cause a processor to perform methods in accordance with aspects of the disclosure is contemplated.

While illustrative systems and methods as described herein embodying various aspects of the present disclosure are shown, it will be understood by those skilled in the art, that the disclosure is not limited to these implementations. Modifications may be made by those skilled in the art, particularly in light of the foregoing teachings. For example, each of the elements of the aforementioned implementations may be utilized alone or in combination or sub-combination with elements of the other implementations. It will also be appreciated and understood that modifications may be made without departing from the true spirit and scope of the present disclosure. The description is thus to be regarded as illustrative instead of restrictive on the present disclosure.

What is claimed is:

1. A method comprising:
determining, by a computer device, a first model corresponding to a first likelihood that a member of a control group is a buyer of a product based on a plurality of observations corresponding to the control group;
determining, by the computer device, a second model corresponding to a second likelihood that a non-buyer of the product belongs to the control group; and
determining, by the computer device, a score corresponding to a probability that a customer is a swing buyer, the score determined using the first model and the second model.

2. The method of claim 1, wherein the control group comprises individuals not subject to a marketing campaign for the product.

3. The method of claim 2, wherein the non-buyer of the product belongs to one of the control group and a test group, the test group subject to the marketing campaign for the product.

4. The method of claim 1, further comprising:
determining, by the computer device, the first model and the second model based on historical transaction information associated with potential purchasers of the product, the historical transaction information corresponding to a specified time period.

5. The method of claim 4, comprising
receiving, by the computer device, the historical transaction information including transactional information corresponding to at least one product offered by an organization, the historical transaction information including observations corresponding to two or more customers of the organization.

6. The method of claim 5, comprising:
assigning individuals to one of the control group and a test group, wherein the test group comprises individuals subject to a marketing campaign for the product.

7. The method of claim 5, comprising:
randomly assigning individuals to one of the control group and the test group that comprises individuals subject to the marketing campaign for the product.

8. The method of claim 1, wherein determining the score corresponding to the likelihood that an individual is a swing buyer includes determining the score when the size of the control group is different from the size of a test group.

9. The method of claim 1, wherein the second model is determined using a plurality of observations corresponding to members of the control group and a test group, the plurality of observations corresponding to historical transaction information corresponding to customer purchases of the product, wherein the test group receives treatment from a marketing campaign.

10. The method of claim 1, wherein a total of observations associated with the control group is not equal to the total of observations associated with a test group, the observations corresponding to historical transaction information associated with one or more purchases of the product, wherein the test group receives treatment from a marketing campaign.

11. The method of claim 1, wherein the size of the control group is equal to the size of a test group, wherein observations associated with the control group and observations associated with the test group correspond to historical transaction information associated with one or more purchases of the product.

12. An apparatus comprising:
a processor;
a non-transitory memory device communicatively coupled to the processor, the non-transitory memory device storing instructions that, when executed by the processor, cause the apparatus to:
predict, using a first model, a first probability that an individual in a control group will be a buyer of a product;
predict, using a second model, a second probability that a non-buyer of the product is in the control group; and
determine a score based on the first probability and the second probability, the score corresponding to a probability that a person is a swing buyer.

13. The apparatus of claim 12, wherein the non-transitory memory device stores instructions, that when executed by the processor, cause the apparatus to:
determine the first model based on a plurality of historical observations corresponding to a control group using logistic regression, wherein the control group corresponds to a group of individuals not subject to a marketing campaign for the product.

14. The apparatus of claim 12, wherein the non-transitory memory device stores instructions, that when executed by the processor, cause the apparatus to:
determine the second model based on a number of historical observations corresponding to members of a control group not subject to a marketing campaign for the product and members of a test group subject to the marketing campaign for the product.

15. The apparatus of claim 14, wherein the non-transitory memory device stores instructions, that when executed by the processor, cause the apparatus to:
determine the second model by logistic regression using a dependent variable indicative of whether a particular observation belongs to the control group.

16. The apparatus of claim 12, wherein the non-transitory memory device stores instructions, that when executed by the processor, cause the apparatus to:
receive historical transaction information corresponding to the product, the historical transaction information including observations indicative of whether two or more individuals were purchasers of the product.

17. The apparatus of claim 12, wherein the non-transitory memory device stores instructions, that when executed by the processor, cause the apparatus to:
rank the score determined for individual observations in a set of transaction data to determine a group of swing buyers having a higher likelihood to purchase the product when subject to a marketing campaign.

18. The apparatus of claim 17, wherein the non-transitory memory device stores instructions, that when executed by the processor, cause the apparatus to:
communicate a report indicative of likely swing buyers to a user for use when developing the marketing campaign for the product.

19. A system comprising:
a data repository storing historical information including a plurality of observations corresponding to a product associated with a business;
a computer device including:
at least one processor; and
a non-transitory memory device storing instructions that, when executed by the at least one processor, configure the computer device to:
obtain a first portion of the historical information associated with a control group, the control group corresponding to individuals not subject to a marketing campaign for the product;
obtain a second portion of the historical information associated with a test group, the test group corresponding to individuals subject to the marketing campaign;
determine a first model corresponding to a first likelihood that an individual in the control group is a buyer of the product based on the plurality of observations corresponding to the control group;
determine a second model corresponding to a second likelihood that a non-buyer of the product is associated with the control group; and
determine a score corresponding to a probability that a customer buys the product when subject to the marketing campaign for the product, the score determined using the first model and the second model.

20. The system of claim 19, wherein the non-transitory memory device stores instructions that, when executed by the processor, configure the computer device to:
determine a score associated with individual observations included in the plurality of observations included in the historical information using the first model and the second model;
compare the score to a criterion, the criterion indicative of whether the individual will purchase the product when subject to the marketing campaign for the product; and
communicate marketing information to the individual associated with the score that meets the criterion.
